(19) United States
(12) Patent Application Publication
(10) Pub. No.: US 2009/0106651 A1
(43) Pub. Date: Apr. 23, 2009

(54) Rendering Data From A Server For Display In A Web Browser On A Client Computer

(76) Inventor: Christopher P. Gorog, Colorado Springs, CO (US)

Correspondence Address: HANES & SCHUTZ, LLC, 102 SOUTH TEJON ST., SUITE 800, COLORADO SPRINGS, CO, 80903, US

(21) Appl. No.: 11/875,543

(22) Filed: Oct. 19, 2007

(51) Int. Cl. G06F 17/00; G06F 17/20; G06F 17/21

(52) U.S. Cl. 715/273; 715/235

(57) ABSTRACT

Data from a server is rendered for display in a web browser on a client computer. At least one static page is retrieved from the server. Data instructions for rendering the data are requested from the server. In response to the request for data and instructions, data and instructions for rendering the data are received. Received data and instructions for rendering are stored on the client. The data is rendered for display using the at least one static page and the instructions for rendering the data.

### BACKGROUND OF THE INVENTION

Often it is desirable for a user using a web browser to retrieve sets of data from a server, manipulate the data, view the data in different forms, and make changes to the data. Conventionally, this is accomplished by the server rendering the data into a web viewable document and providing the web viewable document to the web browser. Each time the data is manipulated or viewed in a different form, the data is re-rendered by the server and again provided to the web browser. When the sets of data are large, this conventional process requires large amounts of bandwidth and server processing time to effect the changes and transmit the data to the web browser.

### DESCRIPTION OF THE DRAWINGS

FIG. 1 is a block diagram of an embodiment of a system for rendering data from a server for display in a web browser on a client computer.

FIGS. 2a and 2b are a more detailed block diagram of an embodiment of the system for rendering data from a server for display in a web browser on a client computer shown in FIG. 1.

FIG. 3 is a flow chart showing one embodiment of a method for rendering data from a server for display in a web browser on a client computer.

### DETAILED DESCRIPTION OF THE INVENTION

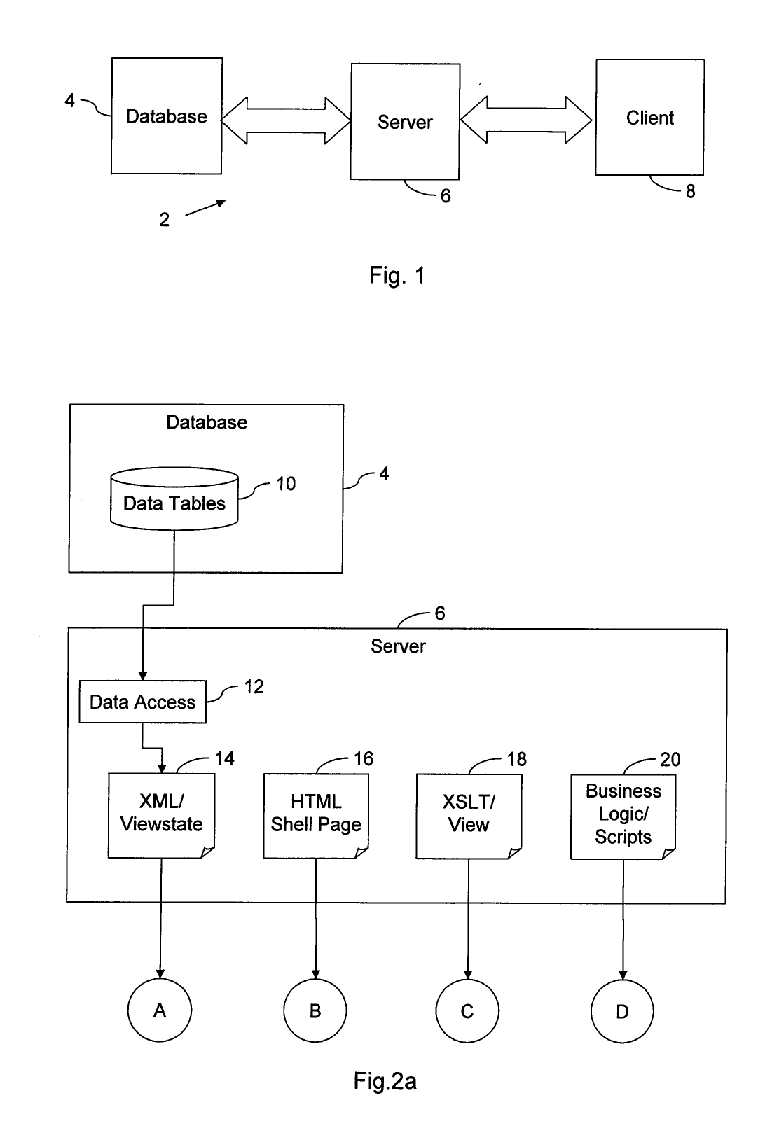

FIG. 1 shows one embodiment of a system 2 according to the present invention. System 2 includes database 4, server 6, and client computer 8. Server 6 is in communication with database 4 and client 8. In one embodiment, Server 6 communicates with database 4 and client 8 over a network. The network may be any type of network such as a local area network, a wide area network, or the Internet.

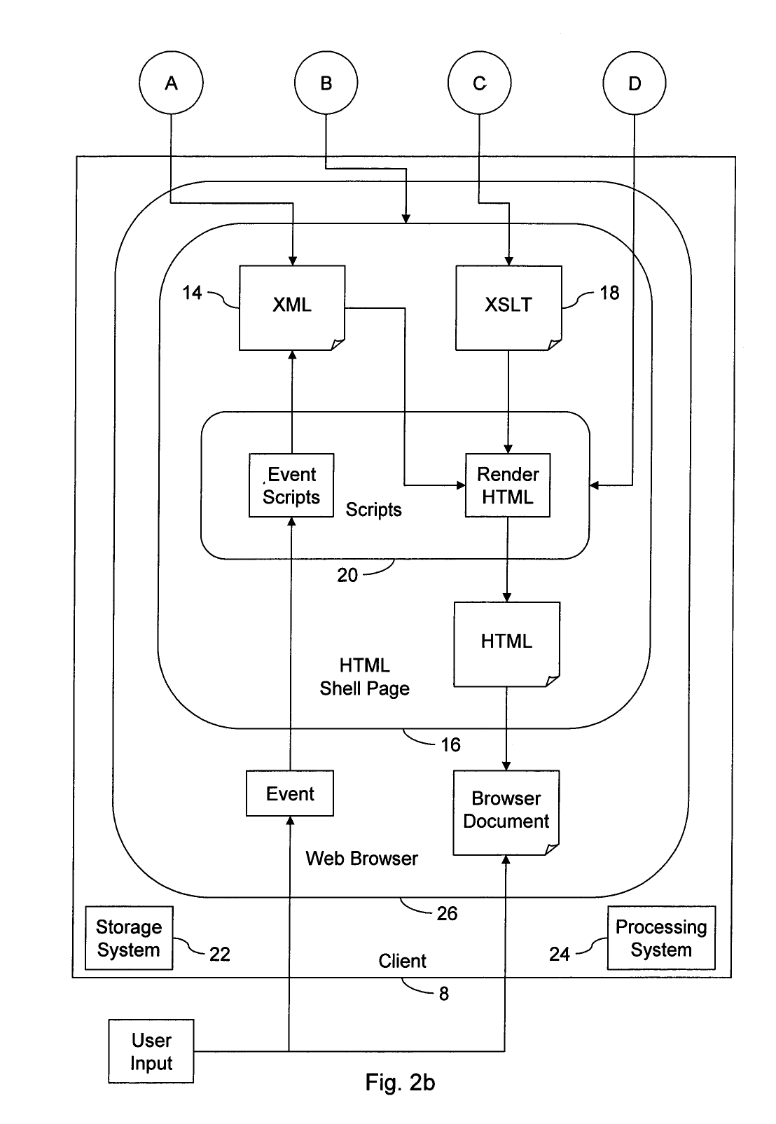

Illustrated in FIG. 2a are database 4 and server 6. Database 4 includes Data Tables 10 containing data to be rendered for display in a web browser on client computer 8. Database 4 is illustrated in FIG. 2a as a single device. Alternatively, database 4 may include more than one device. Furthermore, database 4 may be embodied separately from server 6 or integral with server 6.

Server 6 includes data access sub-system 12, extensible markup language (XML)/ViewState 14, and several static pages 16-20. Data access sub-system 12 accesses data tables 10 of database 4. XML/ViewState 14 is an XML form of the data to be rendered for display in a web browser on client computer 8. In addition to the data included in XML/ViewState 14 are instructions, also called ViewState, for rendering the data. In one embodiment, the ViewState together with the at least one static page 15-20 includes all the information necessary to a web browser for rendering the data for display on client computer 8.

The illustrated static pages 16-20 are exemplary only and other static pages may be substituted for static pages 16-20. The illustrated static pages of server 6 are hyper text markup language (HTML) Shell Page 16, extensible style sheet language transforms (XSLT)/View 18, and Business Logic/Scripts 20.

XSLT 18 is used to render the data for display in a web browser on client computer 8. In one embodiment, XSLT 18 contains instructions for rendering the data in all possible formats available to the user for displaying the data.

Upon initialization, scripts 20 may perform any or all of the following, as further discussed below. In one embodiment, all of the following are performed in asynchronous mode, except for J) and K) which are performed in sequence after A) through I) are performed.

A) Retrieve the XML document 14 containing data and ViewState.

B) Create document object model (DOM) objects for XML and XSL/XSLT 18.

C) Create XSL Transform Objects.

D) Load the data into a unique DOM object “Data DOM” (DDOM).

E) Add any required ViewState data to DDOM.

F) Retrieve XSL/XSLT 18.

G) Load XSLT 18 into a unique DOM object “Style DOM” (SDOM).

H) Repeat E) and F) for additionally required SDOM.

I) Run XML output transformation for filtering or sorting.

J) Run HTML output transformation to produce page view.

K) Insert Page view HTML into browser document object using dynamic HTML (DHTML).

Illustrated in FIG. 2b is client computer 8. Client computer 8 includes a storage system 22, a processing system 24, and a web browser 26. Processing system 24 is any combination of hardware and executable code configured to render data from server 6 for display in a web browser 26 on client computer 8.

Storage system 22 is any device or system configured to store data or executable code. Storage system 22 may also be a program storage system tangibly embodying a program, applet, or instructions executable by processing system 24 for performing the method steps of the present invention executable by processing system 24. Storage system 22 may be any type of storage media such as magnetic, optical, or electronic storage media.

Storage system 22 is illustrated in FIG. 2b as a single device. Alternatively, storage system 22 may include more than one device. Furthermore, each device of storage system 22 may be embodied in a different media type. For example, one device of storage system 22 may be a magnetic storage media while another device of storage system 22 is an electronic storage media.

Web browser 26 is any type of software application for enabling a user to display and interact with text, images, and other information located on a web page at a website on the World Wide Web or a local area network.

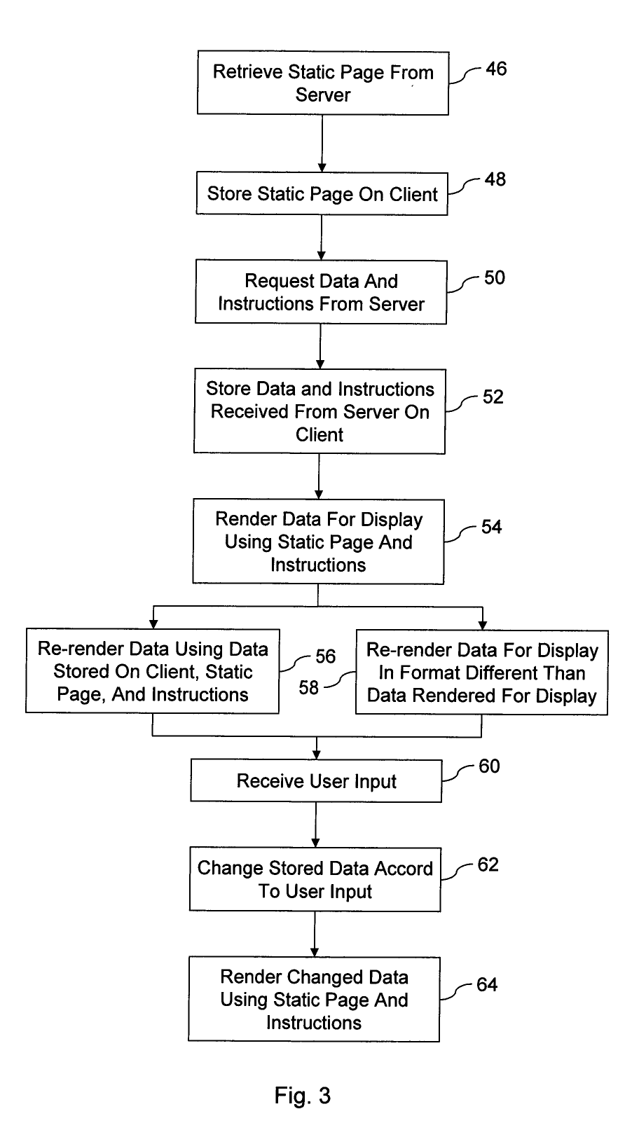

FIG. 3 is a flow chart representing steps of one embodiment of the present invention. Although the steps represented in FIG. 3 are presented in a specific order, the present invention encompasses variations in the order of steps. Furthermore, additional steps may be executed between the steps illustrated in FIG. 3 without departing from the scope of the present invention.

At least one static page 16-20 is retrieved 46 from server 6. In one embodiment, the initial call to the static page is a Web Http get. The Get returns a shell page 16 of HTML markup. The shell page 16 can be retrieved by any active or inactive web post-able type retrieval method or data retrieval method, for example servlet, Java server page, static HTML page, XML (with XSLT referenced link), and active server page. In one embodiment, the at least one static page 16-20 is stored 48 on client 8.

The HTML encoded in HTML shell page 16 provides a framework which contains at least one HTML element tag with id attributes that are uniquely identified and can be referenced for dynamic insertion of HTML code. In one embodiment, HTML shell page 16 also has a default view to display to the user in the case that an error occurs which causes the initial render to not complete.

In one embodiment, the at least one static page 16-20 includes scripts 20. Scripts 20 may be embodied in various ways. HTML shell page 16 may contain loading references to Cascading Style Sheets (CSS), loadable JavaScript pages, loadable script pages, and other browser compatible languages. HTML shell page 16 may also directly include script functionality coded into script sections of the HTML.

Scripts 20 may handle the process to create an instance of XML HTTP responses objects, XML DOM objects, and XML transform objects. Scripts 20 may also contain all location information for loading the proper XML data set and XSL/XSLT files in predefined variables.

After the at least one static page 16-20 is retrieved 46 from server 6, data and instructions (ViewState) necessary for rendering the data are requested 50 from server 6. In one embodiment, requesting 50 data and instructions from server 6 includes loading the at least one static page 16-20 and the at least one static page 16-20 requesting 50 data and instructions from server 6. In one embodiment, the data and instructions from server 6 includes data retrieved by server 6 from database 4. In one embodiment, retrieving data and instructions is the only server side operations performed in this model. Data is retrieved by calling a web service and sending Query parameters. The web service then returns the data in a streamlined XML document 14 along with the ViewState. Alternatively, the data is retrieved by any means which produces the data in XML format to the client 8.

The page model of the present invention based around a central “data persistence” and all development centers around this data object. The data object originates as relational XML containing all the required data for the page. At a high level this model inserts data into an XML data record 14, in order for the XML data record 14 to contain the information necessary to define how it should appear in a view. Within a JavaScript source this page retrieves the data object either with the ViewState already inserted or inserts it after retrieving.

Data received from server 6 is stored 52 on client 8. In one embodiment, storing 52 the data includes persisting the data in XML format in a DOM object.

In one embodiment, the ViewState includes information within the XML DOM document that is read during the transformation by XSL/XSLT 18 to determine the output of the transformation as pertaining to the users view or preference. This information is usually very minimal and will be read both at the beginning of the transformation to set up global view determination and throughout the transformation to retrieve individual draw information for groups, components, elements, or attributes that are to be displayed in various formats depending on their individual ViewState setting.

The data is rendered 54 for display using the at least one static page 16-20 and the ViewState. In one embodiment, rendering 54 the data for display includes rendering a view from the data using static XSLT 18 and the ViewState. In one embodiment, rendering 54 the data includes rendering the data stored on client 8.

In one embodiment, the use of XSLT's declarative language properties is the centralized mechanism of this process. The data is processed as the transformation is run one time through, thus any required ViewState setting are reduced to as low level as needed to ensure the decisions are valid for the element being drawn. Output of XSL/XSLT 18 is a combination of data in the DDOM and the predefined decisions on how the data is to be transformed which is located in the SDOM. As the HTML is produced by the transformation event function scripts are coded into each drawn element with information necessary to map to its corresponding location in the DDOM. This is accomplished by providing DDOM relational information, Element, element number, and any other indexing information necessary to locate the view component in the DDOM and perform required DDOM manipulation.

In one embodiment, the data is re-rendered 56 using the data stored on client 8, the at least one static page 16-20 and the ViewState. In another embodiment, the data is re-rendered 58 for display in a format different than the format of the data rendered for display.

Dynamically changing the view on the client is accomplished using DHTML. Because the data and the ViewState are maintained on the client machine the page view can be created and recreated by transforming the DDOM with XSL/XSLT 18. The HTML output of XSLT 18 is then inserted into the browser document by retrieving a reference to the uniquely identified HTML element tags and copying it over the existing inside HTML of the tag. Web browser 26 renders the new HTML on the fly and the user sees the output of the transformation.

Users change the view by triggering normal browser events which are mapped to script 20 which make small changes to the DDOM ViewState or data then refresh the dynamic view by replacing what was there with a new transform output.

In one embodiment, a user input is received 60. The stored data is changed 62 according to the user input. The changed data is rendered using the at least one static page 16-20 and the ViewState.

User Events mapped to web browser 26 are received when the selected browser event is triggered by user interaction. The event runs scripts 20 which determine which element in the DDOM is referenced by the user's selection of a viewable HTML item. Then scripts 20 index into the DDOM, retrieves the DDOM element related to the HTML item, makes the desired changes to the element, and triggers the redraw and insertion of the changed DDOM. In one embodiment, each event will include the following sequence of events.

A) Use scripts 20 variables to locate view item in DDOM.

B) Make changes, insertions, or deletions to either the data or ViewState items in DDOM.

C) Run XML output transformation for filtering or sorting.

D) Run HTML output transformation to produce page view.

E) Insert Page view HTML into browser document object using DHTML.

This page model provides a client side approach to data persistence, data manipulation, view state persistence, view state manipulation, view rendering, and event handling, The approach is unique as it provides a very lightweight initial post of data and a streamlined one location data model. XML is the main format of page data persistence with XSL and XSLT 18 used to render view; both are centrally contained within a JavaScript language source or, alternatively, in any other client side scripting language that supports this same functionality.

The foregoing description is only illustrative of the invention. Various alternatives, modifications, and variances can be devised by those skilled in the art without departing from the invention. Accordingly, the present invention embraces all such alternatives, modifications, and variances that fall within the scope of the described invention.

What is claimed is:

1. A method for rendering data from a server for display in a web browser on a client computer, the method comprising:
retrieving at least one static page from the server;
requesting from the server, data and instructions for rendering the data;
in response to the request for data and instructions, receiving data and instructions for rendering the data;
storing on the client, the received data and instructions for rendering the data; and
rendering the data for display using the at least one static page and the instructions for rendering the data.

2. The method of claim 1 further including:
receiving a user input and
changing the stored data according to the user input.

3. The method of claim 2 further including rendering the changed data using the at least one static page and the instructions for rendering the data.

4. The method of claim 1 wherein the at least one static page together with the instructions for rendering the data comprise all information necessary to the web browser for rendering the data for display in the web browser

5. The method of claim 1 wherein the data from the server includes data retrieved by the server from a database.

6. The method of claim 1 wherein requesting data from the server includes:
loading the at least one static page and
the at least one static page requesting data from the server.

7. The method of claim 1 wherein storing the data includes persisting the data in extensible markup language (XML) format in a document object model (DOM) object.

8. The method of claim 7 wherein storing instructions for rendering the data includes persisting instructions for rendering the data in XML format in the DOM object.

9. The method of claim 1 wherein rendering the data for display includes rendering a view from the data using static extensible stylesheet language transformations (XSLT).

10. The method of claim 1 wherein rendering the data includes rendering the data stored on the client.

11. The method of claim 1 further including storing the at least one static page on the client.

12. The method of claim 1 further including re-rendering the data using the data stored on the client, the at least one static page, and the instructions for rendering the data.

13. The method of claim 1 further including re-rendering the data for display in a format different than the format of the data rendered for display.

14. The method of claim 1 further including re-rendering the data for display in a format different than the format of the data rendered for display using the data stored on the client, the at least one static page, and the instructions for rendering the data.

15. A program storage system readable by a computer, tangibly embodying a program, applet, or instructions executable by the computer to perform a method for rendering data from a server for display in a web browser on a client computer, the method comprising:
retrieving at least one static page from the server;
requesting from the server, data and instructions for rendering the data;
in response to the request for data and instructions, receiving data and instructions for rendering the data;
storing on the client, the received data and instructions for rendering the data; and
rendering the data for display using the at least one static page and the instructions for rendering the data.

16. The program storage device of claim 15 wherein the method further includes:
receiving a user input and
changing the stored data according to the user input.

17. The method of claim 16 wherein the method further includes rendering the changed data using the at least one static page and the instructions for rendering the data.

18. The program storage device of claim 15 wherein the at least one static page together with the instructions for rendering the data comprise all information necessary to the web browser for rendering the data for display in the web browser

19. The program storage device of claim 15 wherein the data from the server includes data retrieved by the server from a database.

20. The program storage device of claim 15 wherein requesting data from the server includes:
loading the at least one static page and
the at least one static page requesting data from the server.

21. The program storage device of claim 15 wherein storing the data includes persisting the data in extensible markup language (XML) format in a document object model (DOM) object.

22. The method of claim 21 wherein storing instructions for rendering the data includes persisting instructions for rendering the data in XML format in the DOM object.

23. The program storage device of claim 15 wherein rendering the data for display includes rendering a view from the data using static extensible stylesheet language transformations (XSLT).

24. The program storage device of claim 15 wherein rendering the data includes rendering the data stored on the client.

25. The program storage device of claim 15 wherein the method further includes storing the at least one static page on the client.

26. The program storage device of claim 15 wherein the method further includes re-rendering the data using the data stored on the client, the at least one static page, and the instructions for rendering the data.

27. The program storage device of claim 15 wherein the method further includes re-rendering the data for display in a format different than the format of the data rendered for display.

28. The program storage device of claim 15 wherein the method further includes re-rendering the data for display in a format different than the format of the data rendered for display using the data stored on the client, the at least one static page, and the instructions for rendering the data.
